(19) United States
(12) Patent Application Publication
(10) Pub. No.: US 2019/0379221 A1
(43) Pub. Date: Dec. 12, 2019

(54) Device And Method To Tether Charging Apparatus

(71) Applicant: Boaz Turner, Naperville, IL (US)

(72) Inventor: Boaz Turner, Naperville, IL (US)

(21) Appl. No.: 16/002,184

(22) Filed: Jun. 7, 2018

(51) Int. Cl. H02J 7/00

(52) U.S. Cl. CPC H02J 7/0042

(57) ABSTRACT

Disclosed is a device for tethering together the various parts of portable electronic device battery charging apparatus. The device consists of a notched base and an elastic ring connected by a cord. The base is affixed to a standard AC-DC plug-in charging block by an adhesive strip. One end of a charging cord is fed through the device's elastic ring, which has an inner diameter no greater than the width of the charging cord. Because the diameter of the elastic ring is less than the prong-ends of the charging cord, it will not easily slip off. The charging cord is further secured by pushing a segment into the notch on the base. The notch is sized to squeeze the charging cord, thus holding it. In this way, a charging cord and charging block are tied together to prevent loss.

### CROSS-REFERENCE TO RELATED APPLICATIONS

Not applicable.

### FIELD OF THE INVENTION

This invention relates generally to the management of electronic cords and chargers, particularly those used for cell phones and other portable electronics.

### BACKGROUND OF THE INVENTION

The advent of cell phones and portable electronic computing devices has offered people at every level of society instant access to other people and information, opening a portal to every form of entertainment and educational medium capable of being communicated via an interactive touch screen with audio. It is the rare individual who does not own such a device. Indeed, in the United States, eighty-percent of households below the poverty line have cell phones. Accompanying each one of these electronic lifelines to the world at large, there is a battery with a tenuous charge capacity, and apparatus to recharge it.

Charging apparatus consists of a charging cord, and an AC to DC converter—often referred to as a “block” because of its shape. The block has electrical prongs for use with standard AC outlets, and at least one port for insertion of one end of the charging cord, generally a USB port. The charging cord itself has a prong-head at each end, each prong-head being wider than the charging cord itself, One charging cord prong inserts into the port on the charging block (generally a USP connection), and the other is inserted into the electronic device. AC current is converted to DC current in the charging block and transmitted to the battery in the portable device, recharging it. Unfortunately, as important as they may be, the cord and block are too large and unwieldy to incorporate into the electronic device they service and must be separately stored. Inevitable they are either temporarily misplaced, or lost altogether, in whole or part.

There is a need for devices to keep the charging parts of electronic devices together to avoid the frustration of being unable to charge a dead battery, and the expense of having to buy new parts, sometimes at odd hours and in unfamiliar places.

### SUMMARY OF THE INVENTION

This invention is designed to tether a charging block to its charging cord. It is comprised of a base and an elastic ring connected by a cord. The elastic ring has an eyelet the diameter of a standard charging cord width and can be stretched over either prong-head of the charging cord. When relaxed to its natural size, the elastic ring will not easily pass over either of the charging cord prong-heads, thus securing itself to the charging cord. The base is a block, small enough to be attached to a charging block, having a notch on its top side and an adhesive strip on its bottom side. When the base is secured to a charging block by the adhesive strip, and the elastic ring is stretched around a charging cord, the charging block and charging cord are tethered. Additional security is offered by the notch in the base. The notch is slightly less wide than the width of standard charging cord. When part of the length of the charging cord is pressed into the notch, the cord is secured by compression.

### BRIEF DESCRIPTION OF DRAWINGS

FIG. 1 is a side view of the invention with the notched side of the base facing up.

FIG. 2 is a side view of the invention with the adhesive side of the base facing up.

FIG. 3 shows the invention as it was designed to be used, connecting a charging block to a charging cord.

### DETAILED DESCRIPTION OF THE INVENTION

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail beyond the particular implementation choices shown. That is, there are numerous modifications and variations of the invention that are too numerous to be listed, but that all fit within the scope of the invention. Also, singular words should be read as plural, and vice versa, and masculine as feminine, and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or,” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention, Structures described herein are to be understood also to refer to functional equivalents of such structures.

Although Claims have been formulated in this Application to particular combinations of features, it should be understood that the scope of the disclosure of the present invention also includes any novel feature, or any novel combination of features, whether or not it relates to the same invention as presently claimed in any Claim, and whether or not it mitigates any or all of the same technical problems as does the present invention.

Features which are described in the context of separate embodiments may also be provided in combination in a single embodiment. Conversely various features which are, for brevity, described in the context of a single embodiment may also be provided separately or in any suitable sub-combination. The Applicants hereby give notice that new Claims may be formulated to such features, or combinations of such features, during the prosecution of the present Application, or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art, many careful considerations and compromises typically must be made when designing for the optimal manufacture of a commercial implementation any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, improved or optimized by those skilled in the art, using their average skills and known techniques, to achieve the desired implementation that addresses the needs of the particular application.

The invention is best understood by reference to the drawings.

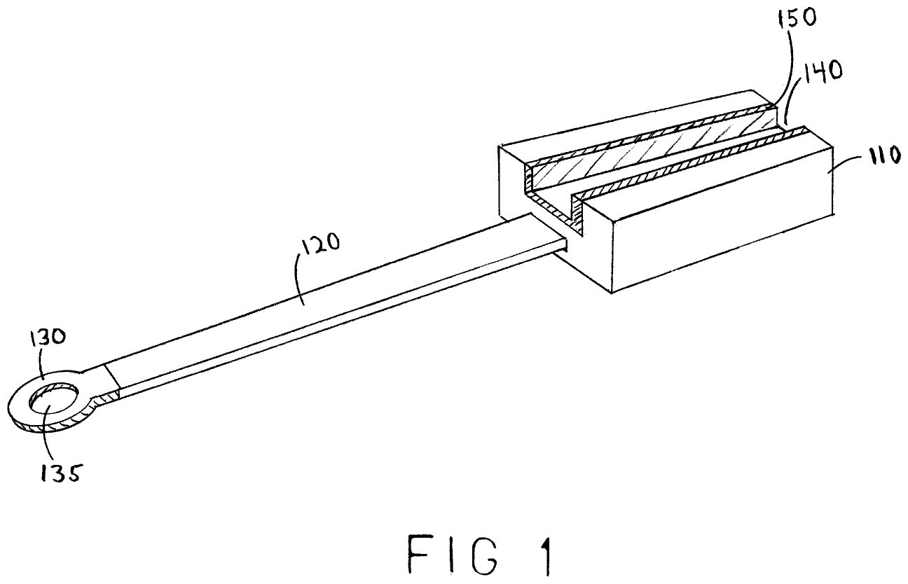

FIG. 1 shows the device 100 comprising a base 110 and an elastic ring 130 connected by a connector cord 120. In an embodiment, the base 110 is a rectangular block with a notch 140 running lengthwise along across the middle of its top side. In an embodiment, the notch 140 has a semi-elastic lining 150. The notch 140 with its lining 150 is as wide, or slightly less wide, than the width of a standard charging cord, so that if a portion of a charging cord is pressed into the notch, the charging cord will secure in place by compression. The elastic ring 130 has an eyelet 135 with a diameter that is no greater than the width of a standard charging cord. When the elastic ring 130 is stretched over either prong-end of a charging cord, the prong-ends, being wider than the charging cord, keep the elastic ring from slipping off.

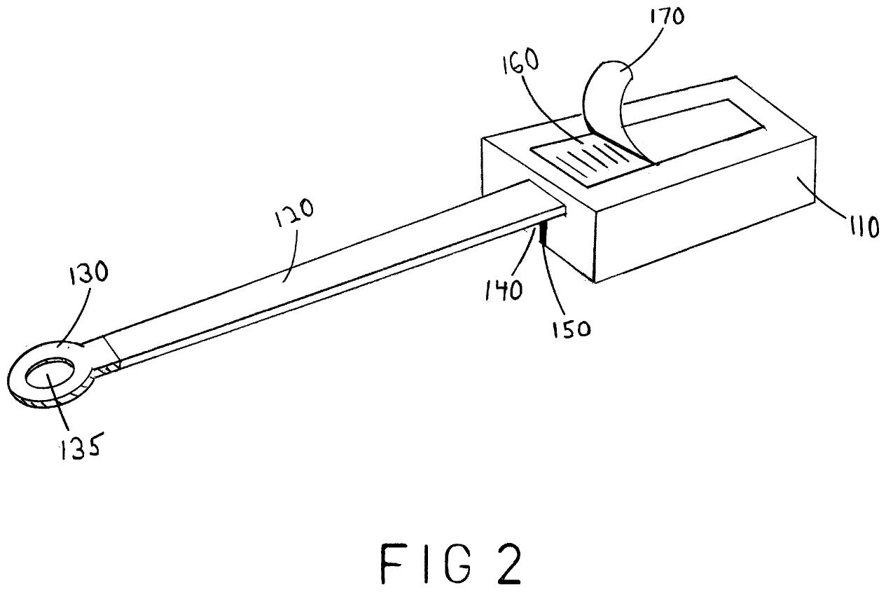

FIG. 2 is a side view of the device with the notch 140 facing down. Running lengthwise through the middle of the base 110 is an adhesive strip 160 with a pull-off tab 170. The elastic ring 130 connects to the base 110 by the connector cord 120. The base 110 is small enough to completely fit on one face of a charging block. By removing the pull-off tab 170 from the adhesive strip 160, the base 110 is affixed to a charging block.

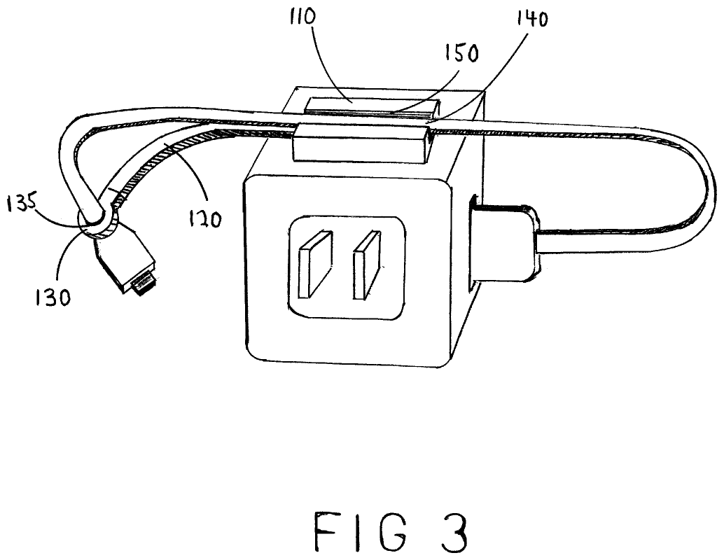

FIG. 3 shows the device in use. The base 110 is affixed to a face of a charging block. The elastic ring 130 wraps around a charging cord, secured to the charging cord by the two prong ends on the charging cord, each of which is larger than the eyelet 135 of the elastic ring 130 in its relaxed position. The charging cord is further secured in the base 110 by the notch 140, here shown with semi-elastic lining 150. The base 110 and the elastic ring 130, each with their holds on the parts of the charging apparatus, are held together by the connector cord 120.

What is claimed:

1. A device to tether battery charging parts for portable electronics, comprising:
(a) a base, said base comprising a block, said block sized to fit on at least one side of a standard AC-DC plug-in converter, and further comprising,
1) a top side and a bottom side,
2) a notch traversing the top side, said notch being no greater in width than the width of a standard portable device charging cord, and
3) an adhesive strip traversing the bottom side,
(b) an elastic ring, said elastic ring having a diameter no greater than the diameter of a standard charging cord, and
(c) a connector cord, said connector cord joining the elastic ring to the base.

2. The claim as in 1, wherein the base is made of a semi-rigid material.

3. The claim as in 1, wherein the base is made of a semi-elastic material.

4. The claim as in 1, wherein the notch is lined with semi-rigid material, for gripping a charging cord.

5. The claim as in 1, wherein the notch is lined with semi-elastic material, for gripping a charging cord.

6. The claim as in 1, wherein the adhesive strip has a pull-off cover.

7. The claim as in 1, wherein the base is a rectangular block one inch in length, one-quarter inch in width, and the notch is one-eighth inch in width.

8. The claim as in 1, wherein the connector cord is two and three-quarters inches in length and one-eighth inch in width.

9. The claim as in 1, wherein the elastic ring has an inner diameter of one-quarter inch.

10. A method for tethering parts of battery charging apparatus for portable electronic devices comprising:
a) removing the pull-off cover from the adhesive strip on the base,
b) attaching the base along the adhesive strip to an open surface on the face of a plug-in AC-DC converter,
c) pulling the elastic ring over one of the prong-ends of a charging cord,
d) plugging the charging cord into the AC-DC converter,
e) plugging the charging cord into the electronic device, and
f) inserting a segment of the charging cord into the notch on the base.
